(19) United States
(12) Patent Application Publication
(10) Pub. No.: US 2017/0306770 A1
(43) Pub. Date: Oct. 26, 2017

(54) THERMAL BOUNDARY PROTECTION SYSTEM

(71) Applicant: SIEMENS AKTIENGESELLSCHAFT, MÜNCHEN (DE)

(72) Inventors: KAI KADAU, LAKE WYLIE, SC (US); MICHAEL CLOSSEN-VON LANKEN SCHULZ, ISSUM (DE)

(21) Appl. No.: 15/516,952

(22) PCT Filed: Oct. 15, 2014
(86) PCT No.: PCT/US2014/060579

§ 371 Date: Apr. 5, 2017

(51) Int. Cl. F01D 5/28; B05D 3/00

(52) U.S. Cl. CPC F01D 5/288; B05D 3/20; F05D 2230/90

(57) ABSTRACT

A thermal boundary protection system including one or more carbon nanotubes for increased durability is disclosed. The thermal boundary protection system may include a bond coat applied on an outer surface of a base material, a thermal barrier coating applied on an outer surface of the bond coat, and a plurality of carbon nanotubes extending from the bond coat at least partially into the thermal barrier coating.

### FIELD OF THE INVENTION

This invention is directed generally to coatings for substrates, and more particularly to thermal barrier coatings used on gas turbine components.

### BACKGROUND

Turbine component life and design depends significantly on cooling flow effectiveness on the airfoil surfaces. Application of coatings provides an additional oxidation and thermal protection to the components thus extending component life. Oftentimes spallation of the thermal barrier coating (TBC) occurs during service on gas turbine engine components like blade foils. The spallation of the thermal barrier coating leads to weak resistance against the surrounding operating conditions, such as temperature and oxidation, for further service operation. Thus, a need exists for a more robust thermal boundary protection system.

### SUMMARY OF THE INVENTION

A thermal boundary protection system including one or more carbon nanotubes for increased durability is disclosed. In at least one embodiment, the thermal boundary protection system may be formed from one or more bond coats applied on an outer surface of the base material, one or more thermal barrier coatings applied on an outer surface of the bond coat and one or more carbon nanotubes extending from the bond coat at least partially into the thermal barrier coating. The carbon nanotubes may be aligned to be generally orthogonal relative to an interface between the bond coat and thermal barrier coating. In other embodiments, the carbon nanotubes may be positioned, such as, but not limited to, randomly at the interface between the bond coat and thermal barrier coating, throughout the bond coat or throughout the bond coat and thermal barrier coating.

In at least one embodiment, the thermal boundary protection system may include a base material having an outer surface, one or more bond coats on the outer surface of the base material, one or more thermal barrier coatings on an outer surface of the bond coat and one or more carbon nanotubes extending from the bond coat at least partially into the thermal barrier coating. The carbon nanotube extending from the bond coat at least partially into the thermal barrier coating may be formed from a plurality of carbon nanotubes extending from the bond coat at least partially into the thermal barrier coating. The plurality of carbon nanotubes may extend generally orthogonal to an interface between the bond coat and the thermal barrier coating. The plurality of carbon nanotubes may be positioned in a hexagonal pattern whereby the plurality of carbon nanotubes are aligned into rows where adjacent rows of carbon nanotubes are offset from each other in a direction aligned with each row. The plurality of carbon nanotubes may be oriented via an electromagnetic field within the bond coat.

In at least one embodiment, the plurality of carbon nanotubes may be positioned throughout the bond coat. The plurality of carbon nanotubes may be positioned throughout the thermal barrier coating. In at least one embodiment, the plurality of carbon nanotubes may be positioned throughout the bond coat and throughout the thermal barrier coating. The carbon nanotube may have a length that is less than a combined thickness of the bond coat and the thermal barrier coating.

A method of providing thermal protection may include applying one or more bond coats to an outer surface of a base material, positioning one or more carbon nanotubes in the bond coat such that the carbon nanotube extends from an outer surface of the bond coat, and applying a thermal barrier coating on an outer surface of the bond coat such that at least a portion of the carbon nanotube is contained within the thermal barrier coating. Positioning one or more carbon nanotubes in the bond coat may include positioning the carbon nanotube in the bond coat via application of an electromagnetic field to the carbon nanotube to orient the carbon nanotube. Positioning the carbon nanotube in the bond coat may include positioning a plurality of carbon nanotubes in the bond coat via application of an electromagnetic field to the carbon nanotube to orient the plurality of carbon nanotubes in a hexagonal pattern whereby the plurality of carbon nanotubes are aligned into rows where adjacent rows of carbon nanotubes are offset from each other in a direction aligned with each row. Positioning the carbon nanotube in the bond coat may include positioning a plurality of carbon nanotubes in the bond coat, wherein the plurality of carbon nanotubes are positioned throughout the at least one bond coat. Positioning the carbon nanotube in the bond coat may include positioning a plurality of carbon nanotubes through the bond coat and the thermal barrier coating.

An advantage of the thermal boundary protection system is that use of the carbon nanotubes extending from the bond coat into the thermal barrier layer increase the strength of the bond between the bond coat and the thermal barrier layer, thereby increasing the useful life of the thermal barrier layer.

These and other embodiments are described in more detail below.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a perspective view of the thermal boundary protection system.

FIG. 2 is a perspective view of the thermal boundary protection system with an electromagnetic field applied to the carbon nanotubes to orient the carbon nanotubes.

FIG. 3 is a cross-sectional side view of the thermal boundary protection system taken at section line 3-3 in FIG. 1.

FIG. 4 is a cross-sectional side view of an alternative embodiment of the thermal boundary protection system taken at section line 3-3 in FIG. 1.

FIG. 5 is a top view of the embodiment of the thermal boundary protection system shown in FIG. 4.

FIG. 6 is a cross-sectional side view of another alternative embodiment of the thermal boundary protection system taken at section line 3-3 in FIG. 1.

FIG. 7 is a cross-sectional side view of yet another alternative embodiment of the thermal boundary protection system taken at section line 3-3 in FIG. 1.

FIG. 8 is a perspective view of an exemplary carbon nanotube.

FIG. 9 is a schematic diagram of a method of using the thermal boundary protection system.

### DETAILED DESCRIPTION OF THE INVENTION

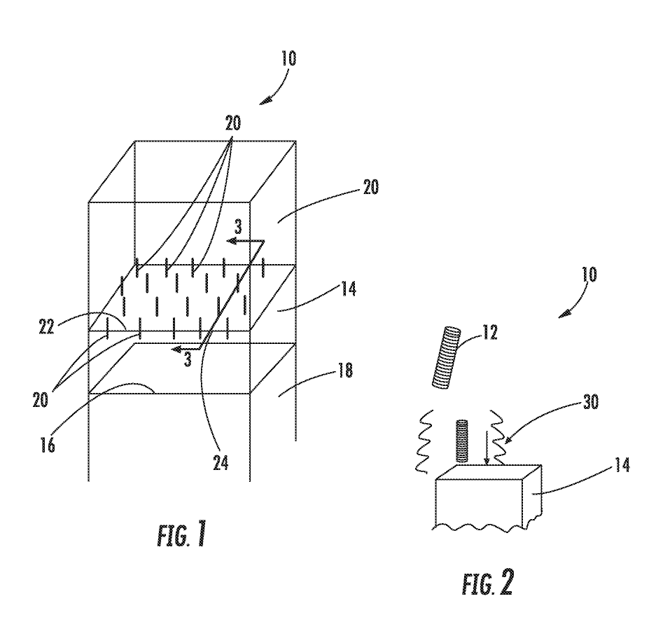

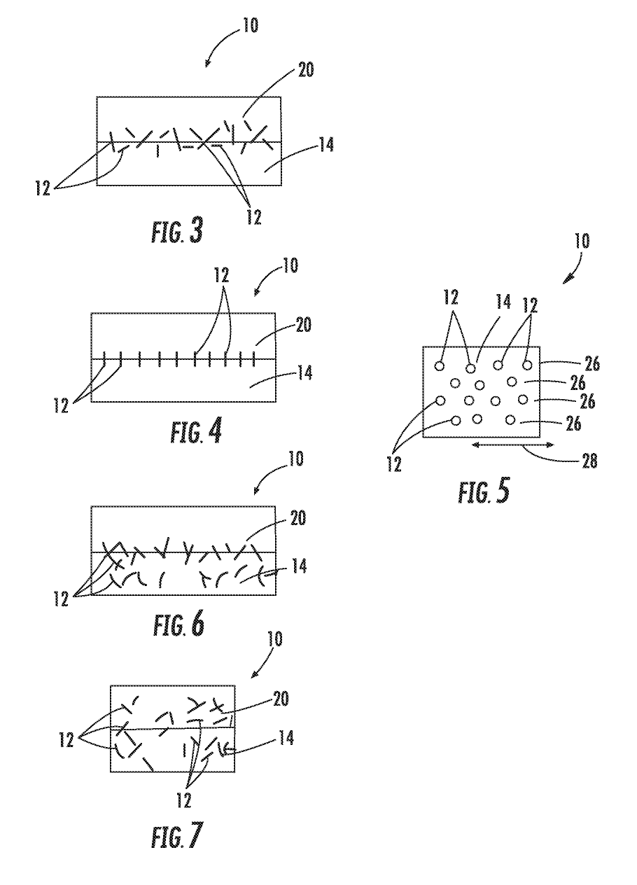

As shown in FIGS. 1-9, a thermal boundary protection system 10 including one or more carbon nanotubes 12 for increased durability is disclosed. In at least one embodiment, the thermal boundary protection system 10 may be formed from one or more bond coats 14 applied on an outer surface 16 of the base material 18, one or more thermal barrier coatings 20 applied on an outer surface 22 of the bond coat 14 and one or more carbon nanotubes 12 extending from the bond coat 14 at least partially into the thermal barrier coating 20. The carbon nanotubes 12 may be aligned to be generally orthogonal relative to an interface 24 between the bond coat 14 and thermal barrier coating 20. In other embodiments, the carbon nanotubes 12 may be positioned, such as, but not limited to, randomly at the interface 24 between the bond coat 14 and thermal barrier coating 20, throughout the bond coat 14 or throughout the bond coat 14 and thermal barrier coating 20.

In at least one embodiment, the thermal boundary protection system 10 may be formed from a base material 18 having an outer surface 16, one or more bond coats 14 on the outer surface 16 of the base material 18, one or more thermal barrier coatings 20 on an outer surface 22 of the bond coat 14, and one or more carbon nanotubes 12 extending from the bond coat 14 at least partially into the thermal barrier coating 20. The carbon nanotubes 12 may be formed from any appropriate configuration. In at least one embodiment, the carbon nanotubes 12 may be a single wall carbon nanotube shaped as a shaft with circular cross-sectional area, as shown in FIG. 8. However, the geometry of the carbon nanotubes 12 is not limited to this configuration but may have other configurations as well. In at least one embodiment, the carbon nanotube 12 may have a length that is less than a combined thickness of the bond coat 14 and the thermal barrier coating 20. In general, the length of the carbon nanotubes 12 may be significantly less than the thickness of the bond coat 14 and thermal barrier coating 20 of the thermal boundary protection system 10. Moreover, a distribution of different carbon nanotube lengths may be beneficial for the desired stability of the thermal boundary protection system 10. In addition to the single walled carbon nanotubes shown in FIG. 8, multi-walled carbon nanotubes and carbon nanobuds (nanobuds are nanotubes with additional perpendicular bulges that can provide additional stability) can be applied. In general, the density of carbon nanotubes near the interface and in the different coating layers may be less than 5%. The base material 18 may be formed from any appropriate material, such as, but not limited to, one or more metals, such as alloys, and in particular, for gas turbine applications Ni- or Co-based super-alloys. The bond coat 14 may be formed from materials, such as, but not limited to, Ni Cr Al Y (oftentimes they are labeled as M Cr Al Y, whereas the M reflects metallic elements such as Ni and Cr). The base material 18 may form a turbine airfoil usable in a gas turbine engine, other components of a gas turbine engine or other components. The thermal barrier coating 20 may be formed from materials, such as, but not limited to, ZrO2-Y2 O3, ZrO2-MgO, LaAlO3, NdAlO3, La2Hf2O7, ErAlO3, GdAlO3, Yb2Ti2O7, LaYbO3, and Gd2Hf2O7.

In at least one embodiment a plurality of carbon nanotube 12 may extend from the bond coat 14 at least partially into the thermal barrier coating 20. As shown in FIGS. 1, 4 and 5, the plurality of carbon nanotubes 12 may extend generally orthogonal to the interface 24 between the bond coat 14 and the thermal barrier coating 20. In at least one embodiment, as shown in FIG. 5, the plurality of carbon nanotubes 12 may be positioned in a hexagonal pattern whereby the plurality of carbon nanotubes 12 are aligned into rows 26 where adjacent rows of carbon nanotubes are offset from each other in a direction 28 aligned with each row 26. The position of the plurality of carbon nanotubes 12 extending generally orthogonal to the interface 24 between the bond coat 14 and the thermal barrier coating 20 and the hexagonal pattern of the plurality of carbon nanotubes 12 may enhance structural stability of the thermal barrier coating 20 attached to bond coat 14. The plurality of carbon nanotubes 12 may be oriented within the bond coat 14 via an electromagnetic field 30. The carbon nanotubes 12 are excellent conductors and can be accelerated and oriented via the electromagnetic field 30, which may be an alternating current electromagnetic field 30.

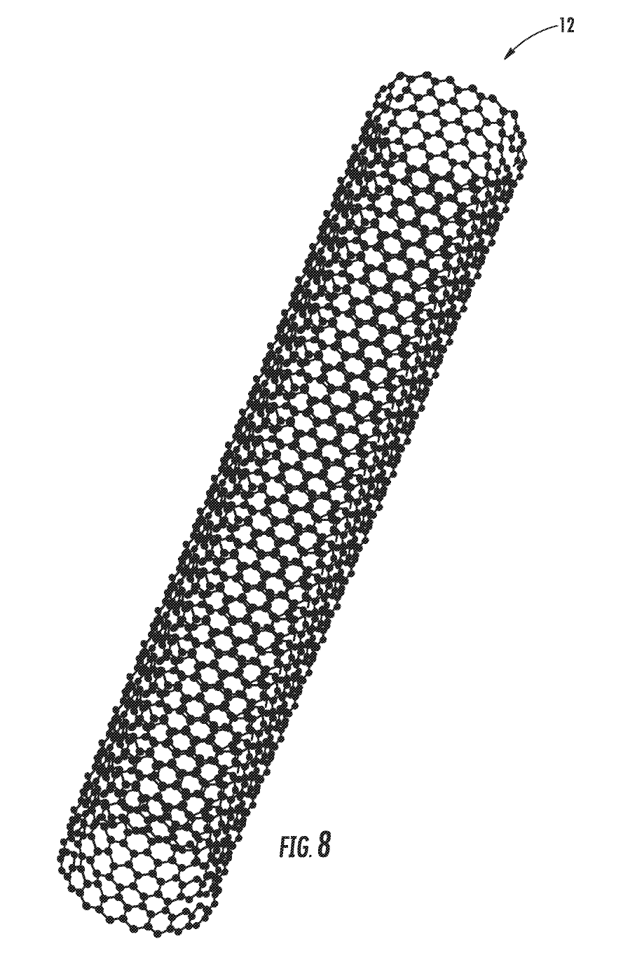

The thermal boundary protection system 10 may have an number of different configurations. For instance, as shown in FIG. 6, the plurality of carbon nanotubes 12 may be positioned throughout the bond coat 14. In the embodiment, shown in FIG. 6, the carbon nanotubes 12 may have random orientations within the bond coat 14. The carbon nanotubes 12 may be positioned randomly throughout the bond coat 14 or may be specifically aligned or positioned in a pattern within the bond coat 14. A portion of the carbon nanotubes 12 may extend from the bond coat 14 into the thermal barrier coating 20.

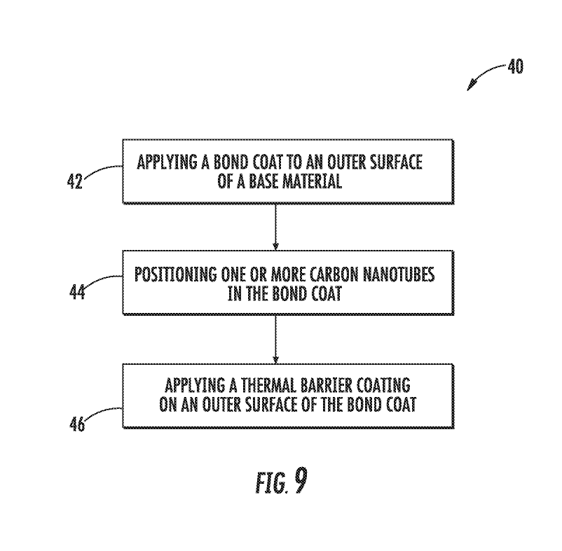

In another embodiment, as shown in FIG. 7, the plurality of carbon nanotubes 12 may be positioned throughout the thermal barrier coating 20. In the embodiment, shown in FIG. 7, the carbon nanotubes 12 may have random orientations within the thermal barrier coating 20. The carbon nanotubes 12 may be positioned randomly throughout the thermal barrier coating 20 or may be specifically aligned or positioned in a pattern within the thermal barrier coating 20. A portion of the carbon nanotubes 12 may extend from the thermal barrier coating 20 into the bond coat 14. The carbon nanotubes 12 may extend throughout the bond coating 14, throughout the thermal barrier coating 20 and at least some of the carbon nanotubes 12 may extend between the bond coat 14 into the thermal barrier coating 20.

A method of providing thermal protection 40, as shown in FIG. 9, may include applying at 42 one or more bond coats 14 to an outer surface 16 of a base material 18. The method 40 may also include positioning at least one carbon nanotube 12 in the bond coat 14 at 44 such that the carbon nanotube 12 extends from an outer surface 22 of the bond coat 14. The method may also include applying at 46 a thermal barrier coating 20 on an outer surface 22 of the bond coat 14 such that at least a portion of the carbon nanotube 12 is contained within the thermal barrier coating 20. Positioning the carbon nanotube 12 in the bond coat 14 at 44 may include positioning the carbon nanotube 12 in the bond coat 14 via application of an electromagnetic field to the carbon nanotube 12 to orient the carbon nanotube 12.

Positioning the carbon nanotube 12 in the bond coat 14 at 44 may include positioning a plurality of carbon nanotubes 12 in the bond coat 14 via application of an electromagnetic field to the carbon nanotube 12 to orient the plurality of carbon nanotubes 12 in a hexagonal pattern whereby the plurality of carbon nanotubes 12 are aligned into rows 26 where adjacent rows 26 of carbon nanotubes 12 are offset from each other in a direction 28 aligned with each row 26. Positioning the carbon nanotube 12 in the bond coat 14 at 44 may include positioning a plurality of carbon nanotubes 12 in the bond coat 14, wherein the plurality of carbon nanotubes 12 are positioned throughout the bond coat 14. Positioning the carbon nanotube 12 in the bond coat 14 at 12 may include positioning a plurality of carbon nanotubes 12 throughout the bond coat 14 and the thermal barrier coating 20.

The foregoing is provided for purposes of illustrating, explaining, and describing embodiments of this invention. Modifications and adaptations to these embodiments will be apparent to those skilled in the art and may be made without departing from the scope or spirit of this invention. Additionally, it is to be understood that while the claims set forth process steps in a particular order, the methods of the present invention are not limited to this particular order such that any combination of these process steps that accomplishes one or more aspects of the present invention are to be considered within the scope of the present invention.

We claim:

1-9. (canceled)

10. A thermal boundary protection system comprising:
a base material having an outer surface;
a bond coat on the outer surface of the base material (18);
a thermal barrier coating on an outer surface of the bond coat (14); and
a plurality of discrete carbon nanotubes extending from the bond coat at least partially into the thermal barrier coating.

11. The thermal boundary protection system of claim 10, characterized in that the plurality of carbon nanotubes extend orthogonal to an interface between the bond coat and the thermal barrier coating.

12. The thermal boundary protection system of claim 11, characterized in that the plurality of carbon nanotubes are aligned into rows where adjacent rows of carbon nanotubes are offset from each other in a direction aligned with each row.

13. The thermal boundary protection system of claim 10, characterized in that a plurality of carbon nanotubes are further positioned solely within the bond coat.

14. The thermal boundary protection system of claim 10, characterized in that a plurality of carbon nanotubes are further positioned solely within the thermal barrier coating.

15. The thermal boundary protection system of claim 10, characterized in that the carbon nanotubes each have a length that is less than a combined thickness of the at least one bond coat and the at least one thermal barrier coating.

16. The thermal boundary protection system of claim 10, characterized in that the plurality of carbon nanotubes comprise carbon nanotubes of different lengths.

17. The thermal boundary protection system of claim 10, characterized in that the plurality of carbon nanotubes are oriented randomly with respect to one another.

18. A method of providing thermal protection to a base material, the method comprising:
applying a bond coat to an outer surface of a base material;
positioning a plurality of discrete carbon nanotubes in the bond coat such that the carbon nanotubes extend from an outer surface of the bond coat;
applying a thermal barrier coating on the outer surface of the bond coat such that the carbon nanotubes extend at least partially into the thermal barrier coating.

19. The method of claim 18, characterized in that the positioning comprises applying an electromagnetic field to the carbon nanotubes to orient the plurality of carbon nanotubes orthogonal to an interface between the bond coat and the thermal barrier coating.

20. The method of claim 18, characterized in that the positioning is done such that the plurality of carbon nanotubes are aligned into rows where adjacent rows of carbon nanotubes are offset from each other in a direction aligned with each row.

21. The method of claim 18, characterized in that the positioning further comprises positioning a plurality of the carbon nanotubes solely within the bond coat.

22. The method of claim 18, characterized in that the positioning comprises orienting the plurality of carbon nanotubes randomly with respect to one another.

23. The method of claim 18, characterized in that the plurality of carbon nanotubes comprise carbon nanotubes of different lengths.
